(19) United States
(12) Patent Application Publication
(10) Pub. No.: US 2012/0242909 A1
(43) Pub. Date: Sep. 27, 2012

(54) ILLUMINATING DEVICE, DISPLAY DEVICE, AND TELEVISION RECEIVER

(75) Inventor: Yasumori Kuromizu, Osaka (JP)

(73) Assignee: SHARP KABUSHIKI KAISHA, Osaka (JP)

(21) Appl. No.: 13/514,120

(22) PCT Filed: Oct. 28, 2010
(86) PCT No.: PCT/JP2010/069175

§ 371 Date: Jun. 6, 2012

(30) Foreign Application Priority Data
Dec. 11, 2009 (JP) 2009-281718

(51) Int. Cl. H04N 5/66; F21V 21/00; G02F 1/1335

(52) U.S. Cl. 348/739; 349/61; 362/225

(57) ABSTRACT

Disclosed is an illumination device that can reduce the manufacturing cost of adjustment circuits connected to discharge tubes by reducing the number of the adjustment circuits below the number of the discharge tubes. The illumination device (2) is provided with: a chassis (4); three U-shaped discharge tubes, each of which has electrodes on both ends; and two transformers (10a, 10b). In the plan view of the chassis (4), the electrodes of the three discharge tubes (20) are aligned in one direction. The center portion of the discharge tube (20) located in between is virtually grounded. Among the electrodes aligned in one direction, the four electrodes in between are electrically connected to the transformers (10a, 10b) through relay connectors (14), and the two electrodes at opposite ends are electrically connected to the chassis (4).

### TECHNICAL FIELD

The present invention relates to an illumination device, a display device, and a television receiver.

### BACKGROUND ART

As a backlight device used in a display device, a back light device provided with a discharge tube that has electrodes at two ends of a tubular body, which is bent such that the electrodes are aligned in one direction (U-shaped tube), is known. Typically, in such a backlight device, a power supply substrate is electrically connected to each of the discharge tubes, and power is supplied from the power supply substrate to the discharge tubes so as to turn the discharge tubes on.

Patent Document 1 discloses a backlight device that is provided with: U-shaped discharge tubes, each of which has electrodes at the respective ends; a chassis that houses the plurality of the discharge tubes; and transformers that adjust a voltage applied to the discharge tubes. In this backlight device, the discharge tubes are arranged in parallel with each other such that the respective electrodes of the discharge tubes are aligned in one direction. Also, four transformers are arranged side by side along one side edge of the chassis in which the electrodes are arranged.

In the backlight device of Patent Document 1, when three discharge tubes are housed in the chassis, the electrodes of the respective discharge tubes are connected to three of the four transformers. When four discharge tubes are housed in the chassis, the electrodes of the respective discharge tubes are respectively connected to the four transformers.

### RELATED ART DOCUMENTS

### Patent Documents

Patent Document 1: Japanese Patent Application Laid-Open Publication No. 2007-140393

### Problems to be Solved by the Invention

In the backlight device of Patent Document 1, one transformer is connected to one discharge tube, and therefore, it is necessary to provide at least as many transformers as the discharge tubes housed in the chassis. Because the number of transformers cannot be reduced below the number of discharge tubes, the manufacturing cost of the transformers cannot be reduced.

### SUMMARY OF THE INVENTION

The present invention was made in view of the above-mentioned problem. An object of the present invention is to provide a technique to reduce the manufacturing cost of adjustment circuits by reducing the number of the adjustment circuits connected to discharge tubes below the number of the discharge tubes in an illumination device provided with a plurality of discharge tubes, each of which has electrodes at the respective ends of a tubular body, which is bent such that the electrodes are aligned in one direction. Another object of the present invention is to provide a display device including such an illumination device, and a television receiver including such a display device.

### Means for Solving the Problems

The technique disclosed in the present specification relates to an illumination device, including: a plurality of discharge tubes, each of which has electrodes at respective ends of a tubular body, the tubular body being bent such that the electrodes are aligned in one direction; a chassis that houses the plurality of discharge tubes; and an adjustment circuit that adjusts driving power supplied to the discharge tubes, wherein, in a plan view of the chassis, the discharge tubes are arranged in parallel in the chassis such that the electrodes of the plurality of discharge tubes are aligned in one direction, wherein among the electrodes aligned in one direction, the electrodes in between are electrically connected to the adjustment circuit, and the two electrodes at opposite ends are electrically connected to the chassis, and wherein two or more of the in-between electrodes are electrically connected to the same adjustment circuit.

According to the above-mentioned illumination device, the two electrodes at the opposite ends are not connected to the adjustment circuit, and at least two or more electrodes are connected to one adjustment circuit, and therefore, the number of the adjustment circuits connected to the electrodes can be reduced below the number of the discharge tubes. Therefore, it is possible to reduce the manufacturing cost of the adjustment circuits.

In the above-mentioned illumination device, three or more of the discharge tubes may be arranged in the chassis, and in a plan view of the chassis, among three or more of the discharge tubes arranged in parallel with each other in the chassis, the discharge tube in between may have two electrodes at respective ends thereof connected to the adjustment circuit and a center portion thereof virtually grounded. According to this configuration, even when three or more discharge tubes are arranged in the chassis, the number of the adjustment circuits connected to the electrodes can be reduced below the number of discharge tubes. Therefore, it is possible to reduce the manufacturing cost of the adjustment circuits.

In the above-mentioned illumination device, in a plan view of the chassis, all of the in-between electrodes may be electrically connected to one adjustment circuit. According to this configuration, even when a plurality of discharge tubes is arranged in the chassis, the electrodes can be connected to one adjustment circuit. Therefore, it is possible to reduce the manufacturing cost of the adjustment circuits.

In the above-mentioned illumination device, in a plan view of the chassis, a plurality of the adjustment circuits may be arranged in parallel with each other, and each of the adjustment circuits may be electrically connected to two adjacent electrodes that respectively belong to two adjacent discharge tubes. According to this configuration, the number of the adjustment circuits connected to the electrodes can be less than the number of the discharge tubes by one. Therefore, the number of the adjustment circuits connected to the electrodes can be reduced below the number of the discharge tubes, which allows for a reduction in the manufacturing cost of the adjustment circuits.

In the above-mentioned illumination device, the tubular body may be constituted of two straight sections that are parallel with each other and one curved section formed between the two straight sections; each of the two straight sections may have the electrode at one end and the other end may be continued to the curved section; and, in a plan view of the chassis, a plurality of the discharge tubes may be arranged such that the straight sections constituting the plurality of discharge tubes become parallel with each other. According to this configuration, the plurality of discharge tubes are arranged parallel with each other in the chassis, and therefore, the plurality of discharge tubes can be housed efficiently in the chassis.

In the above-mentioned illumination device, four or more of the discharge tubes may be arranged in the chassis, and in a plan view of the chassis, the respective plurality of discharge tubes may be arranged such that a distance between the respective straight sections of the adjacent discharge tubes becomes larger as the discharge tube is located further away from a center. According to this configuration, the brightness of the center portion of the chassis can be increased as compared with a configuration where the same number of the discharge tubes is arranged at equal distances in the chassis. This allows for a reduction in the power consumption of the illumination device.

In the above-mentioned illumination device, three or more of the discharge tubes may be arranged in the chassis, and in a plan view of the chassis, the plurality of discharge tubes may be configured such that a distance between the straight sections of the same discharge tube varies among the plurality of discharge tubes and such that the distance becomes larger as the discharge tube is located further away from the center. According to this configuration, the brightness of the center portion of the chassis can be increased as compared with a configuration where the same number of discharge tubes arranged in the chassis such that the distances between straight sections that face each other in the respective discharge tubes become equal. This allows for a reduction in the power consumption of the illumination device.

In the above-mentioned illumination device, three of the discharge tubes may be arranged in the chassis. In a plan view of the chassis, distances between the straight sections of the respective discharge tubes may be set to be equal in the two discharge tubes at the opposite ends, and a relation represented by P3>P2 and P2<⅓× (2×b+P3) may be satisfied, where: P2 is a distance between the straight sections that face each other in one discharge tube in between among the discharge tubes; P3 is a distance between the straight sections that face each other in each of the two discharge tubes located outside; and “b” is a distance between the straight sections of respective two adjacent discharge tubes. According to this configuration, the brightness of the center portion of the chassis can be increased when three discharge tubes are arranged in the chassis. This allows for a reduction in the power consumption of the illumination device.

In the above-mentioned illumination device, two of the discharge tubes may be arranged in the chassis. The tubular body may include two straight sections that are parallel with each other and one curved section formed between the two straight sections. Each of the two straight sections may have the electrode at one end, and the other end may be continued to the curved section. In a plan view of the chassis, the plurality of discharge tubes may be arranged such that the straight sections in the plurality of discharge tubes become parallel with each other. The two discharge tubes may satisfy a relation represented by P1>a, where P1 is a distance between the straight sections in each of the discharge tubes, and “a” is a distance between the respective straight sections of the adjacent discharge tubes, which face each other. According to this configuration, the brightness of the center portion of the chassis can be increased when two discharge tubes are arranged in the chassis. This allows for a reduction in the power consumption of the illumination device.

In the above-mentioned illumination device, an alternating current of the same phase may be applied to respective electrodes connected to the same adjustment circuit. According to this configuration, because the respective electrodes connected to the same adjustment circuit maintain the same potential, the reliability of the illumination device such as a breakdown voltage can be improved.

In the above-mentioned illumination device, a half of electrodes connected to the same adjustment circuit may be applied with an alternating current of the same phase, and the remaining half may be applied with an alternating current of the opposite phase. According to this configuration, the same number of electrodes is applied with the alternating currents of the phases opposite to each other, respectively, and therefore, electromagnetic noise generated at the front side of the illumination device can be reduced. This makes it possible to suppress the effect of the electromagnetic noise.

The above-mentioned illumination device may further include a power supply substrate, and in a plan view of the chassis, the electrodes in between may be electrically connected to the power supply substrate. According to this configuration, only the electrodes in between are connected to the power supply substrate. By disposing the power supply substrate only in an area near the electrodes in between, the size of the power supply substrate can be made smaller. This allows for a reduction in the manufacturing cost of the power supply substrate.

In the above-mentioned illumination device, in a plan view of the chassis, the power supply substrate may be arranged between the two electrodes at the opposite ends. This configuration makes it possible to further reduce the size of the power supply substrate.

In the above-mentioned illumination device, the adjustment circuit may be incorporated in the power supply substrate. According to this configuration, the adjustment circuits can be manufactured in the same step as that of the power supply substrate, and therefore, the manufacturing process of the illumination device can be simplified.

In the above-mentioned illumination device, a ground potential of the chassis and a ground potential of the power supply substrate may be equal. According to this configuration, the stable potential between the chassis and the power supply substrate can be ensured, and the discharge tubes can therefore be turned on with ease.

The above-mentioned illumination device may further include a relay connector attached to the chassis, and the electrode may be electrically connected to the power supply substrate through the relay connector. According to this configuration, it is possible to directly connect the discharge tubes to the power supply substrate without using lead wires.

In the above-mentioned illumination device, the discharge tube may include: an outer lead that is formed so as to protrude from an end of the tubular body, the outer lead being supplied with power from the power supply substrate; and a socket that includes a main body that is attached to an outer circumference of the tubular body and a conductive section that extends from the main body and that is connected to the outer lead, the main body being provided with a connecting portion electrically connected to the power supply substrate. The socket may constitute the electrode, and the relay connector may have a socket housing chamber that houses the socket. According to this configuration, because the socket is housed in the socket housing chamber, the discharge tubes can be easily connected to the relay connectors.

In the above-mentioned illumination device, the relay connector may have an insertion opening that allows the power supply substrate to be inserted thereto; the power supply substrate may have, at an edge thereof, an engagement portion that engages the insertion opening; and the relay connector and the power supply substrate may be electrically connected. According to this configuration, because the insertion opening and the engagement portion are engaged with each other, it is possible to achieve a card edge-type connection between the relay connectors and the power supply substrate. This allows the relay connectors to be directly connected to the power supply substrate without using lead wires.

In the above-mentioned illumination device, the engagement portion may have a recess that sandwiches the insertion opening. According to this configuration, it is possible to achieve a card edge-type connection between the relay connectors and the power supply substrate.

In the above-mentioned illumination device, the relay connector may include an insulating holder attached to the chassis, and a relay terminal that is attached to the holder and that can be electrically connected to the power supply substrate and the discharge tube. According to this configuration, a leakage of a current flowing through the relay connectors can be prevented by the holder while securing conduction between the power supply substrate and the discharge tubes by the relay terminal.

The above-mentioned illumination device may further include a ground connector attached to the chassis. In this case, the electrode may be electrically connected to the chassis through the ground connector. According to this configuration, it is possible to directly connect the discharge tubes to the chassis without using lead wires.

In the above-mentioned illumination device, in a plan view of the chassis, the electrodes may be aligned on a straight line that is parallel with a shorter side direction of the chassis. According to this configuration, the electrodes in between can be arranged close to each other, which makes it possible to reduce the size of the adjustment circuit. Moreover, because the discharge tubes are arranged in the chassis such that the respective electrodes are aligned on the above-mentioned straight line, two discharge tubes are efficiently housed in the chassis.

The techniques disclosed in the present specification can be used for a display device including a display panel that performs a display by using light from the above-mentioned illumination device. A display device that includes a liquid crystal panel employing liquid crystals as the display panel is new and useful. A television receiver that includes the above-mentioned display device is also new and useful. According to the above-mentioned display device and television, it is possible to make a display area larger.

### Effects of the Invention

According to the techniques disclosed in the present specification, it is possible to reduce the manufacturing cost of adjustment circuits by reducing the number of adjustment circuits connected to electrodes below the number of discharge tubes in an illumination device provided with a plurality of discharge tubes, each of which has electrodes at the respective ends of a tubular body, and the tubular body is bent such that the electrodes are aligned in one direction.

### BRIEF DESCRIPTION OF THE DRAWINGS

FIG. 1 is an exploded perspective view of a television receiver 100 according to Embodiment 1.

FIG. 2 is a horizontal cross-sectional view of a display device D.

FIG. 3 is a front view of an illumination device 2.

FIG. 4 is a rear view of an illumination device 2.

FIG. 5 is a perspective view of a discharge tube 20.

FIG. 6 is a perspective view of a relay connector 16.

FIG. 7 is a perspective view of a circuit board 6.

FIG. 8 is an explanatory view showing a manner in which a circuit board 6 is connected to a relay connector 14.

FIG. 9 is a rear view of an illumination device 2 according to Embodiment 2.

FIG. 10 is a rear view of an illumination device 2 according to Embodiment 3.

FIG. 11 is a front view of an illumination device 2 according to Embodiment 4.

FIG. 12 is a front view of an illumination device 2 according to Embodiment 5.

FIG. 13 is a front view of an illumination device 2 according to Embodiment 6.

FIG. 14 is a front view of an illumination device 2 according to Embodiment 7.

FIG. 15 is a front view of an illumination device 2 according to Embodiment 8.

### DETAILED DESCRIPTION OF EMBODIMENTS

### Embodiment 1

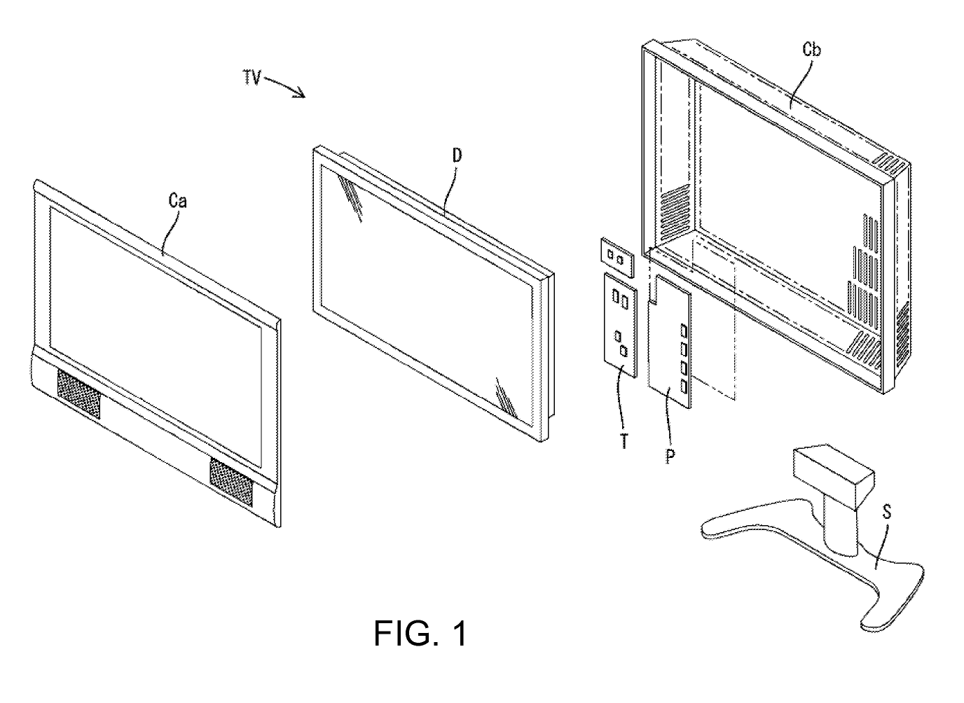

Embodiments will be described with reference to figures. FIG. 1 is an exploded perspective view of a television receiver TV according to Embodiment 1. The television receiver TV includes a display device D, front and rear cabinets Ca and Cb that sandwich and house the display device D, a power source P, a tuner T, and a stand S.

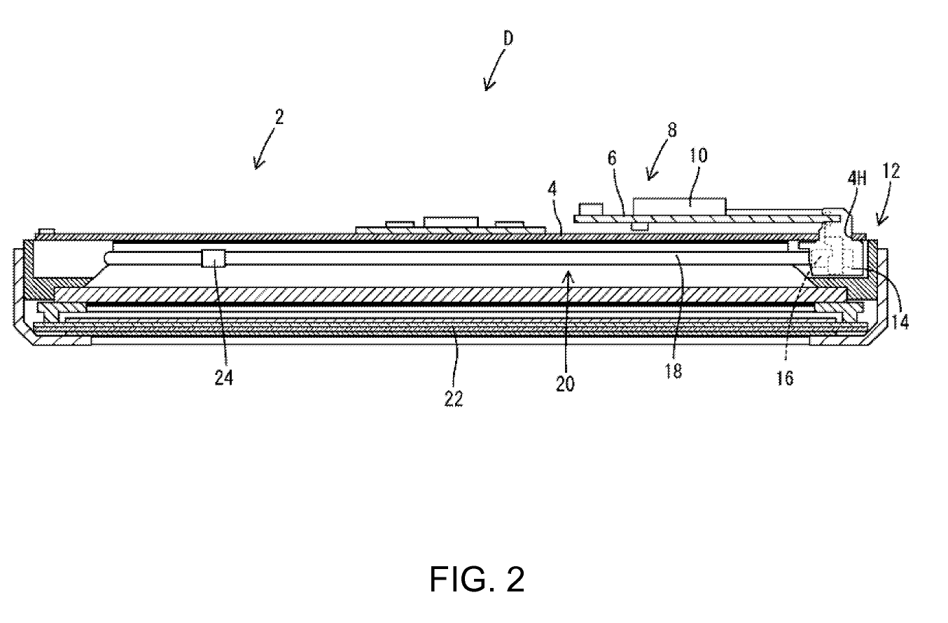

FIG. 2 is a horizontal cross-sectional view of the display device D. The display device D is a so-called liquid crystal display panel, which has a rectangular shape that is horizontally long as a whole, and is provided with a display panel 22 and an illumination device 2 shown in FIG. 2. The display panel 22 is disposed on the front side of the illumination device 2, and the illumination device 2 illuminates the display panel 22 from the back side as a backlight. FIG. 2 is a schematic view of the display device D, and the shapes of the relay connector 14, the power supply substrate 8, and the like will be described in detail with reference to other figures.

Next, the display panel 22 will be described. The display panel 22 has a known structure in which liquid crystal is sealed between a transparent TFT (Thin Film Transistor) substrate and a transparent CF (Color Filter) substrate. The TFT substrate includes TFTs as switching elements that are connected to source wiring lines and gate wiring lines, which cross each other at right angle, and pixel electrodes that are connected to the TFTs. The CF substrate includes a color filter and a common electrode. In the color filter, colored sections of three primary colors: red (R); green (G); and blue (B) are arranged in a matrix.

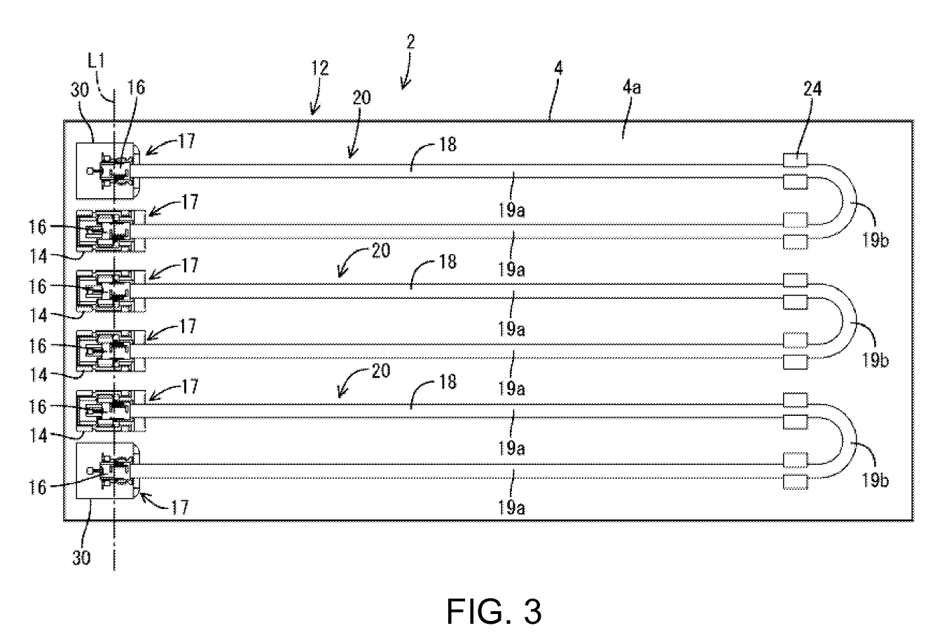

Next, the illumination device 2 will be explained. FIG. 3 is the front view of the illumination device 2. As shown in FIG. 3, the illumination device 2 is provided with a lamp unit 12 that includes a chassis 4 made of a metal, three discharge tubes 20 having the same length and shape, four relay connectors 14, and two ground terminals 30. The chassis 4 has a plate shape that is horizontally long as a whole, and serves as a lamp housing member. A reflective sheet 4a is formed on the inner surface (front side) of the chassis 4. The three discharge tubes 20 are arranged along the vertical direction (shorter side direction of the chassis 4) on the front side of the chassis 4 so as to be parallel with each other. At positions that correspond to the ends of the respective discharge tubes 20, a plurality of substantially square-shaped attachment holes 4H (see FIG. 2) are formed so as to penetrate through the chassis 4 from the front to the back.

The four relay connectors 14 and the two ground terminals 30 are respectively affixed to the chassis 4 through the respective attachment holes 4H, which are formed at the positions that correspond to the ends of the discharge tubes 20. The relay connectors 14 and the ground terminals 30 are vertically aligned (on a straight line L1 that is parallel with the shorter side direction of the chassis 4) along one side edge of the chassis 4 so as to correspond to the ends of the respective discharge tubes 20. Specifically, in a plan view of the chassis 4, the four relay connectors 14 are aligned between the two ground terminals 30 on the straight line L1. In one side edge of the chassis 4, the discharge tubes 20 are affixed to the chassis 4 by the relay connectors 14 and the ground terminals 30. In the other side edge of the chassis 4, the discharge tubes 20 are affixed to the chassis 4 by lamp clips 24.

The discharge tube 20 is made of a cold cathode lamp, and has electrodes 17 at the respective ends of a glass tube 18. The glass tube 18 is constituted of two straight sections 19a that are parallel with each other and one curved section 19b formed between the two straight sections 19a. Each of the two straight sections 19a has an electrode 17 at one end, and the other end is continued to the curved section 19b. The curved section 19b is curved so as to form a semicircular arch. The glass tube 18 has a U-shape made of the two straight sections 19a and the curved section 19b such that the electrodes 17 are aligned in one direction. Each of the electrodes 17 is constituted of a socket 16.

The three discharge tubes 20 arranged in parallel with each other are housed in the chassis 4, and the six electrodes 17 are arranged (on the straight line L1 parallel with the shorter side direction of the chassis 4) so as to be aligned along one side edge of the chassis 4. Further, the three discharge tubes 20 are arranged such that, in the plan view of the chassis 4, the respective straight sections 19a constituting the three discharge tubes 20 become parallel with each other. In the plan view of the chassis 4, among the electrodes 17, the four electrodes 17 in between are connected to the relay connectors 14, and the two electrodes 17 at the opposite ends are connected to the ground terminals 30, respectively. The chassis 4 is made of a metal and is grounded, and therefore, the electrodes 17 connected to the ground terminals 30 maintain a ground potential. The details of the discharge tubes 20 will be described later with reference to other figures.

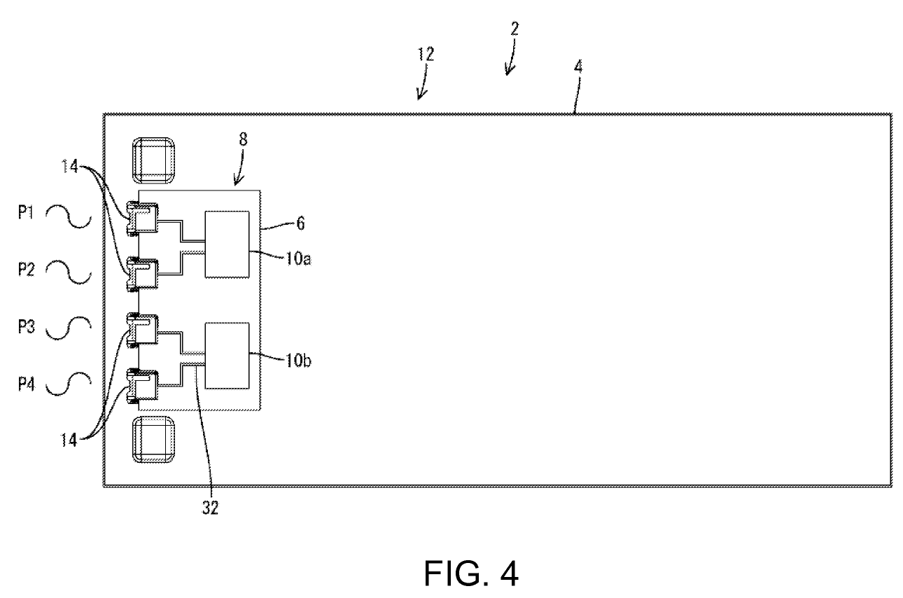

FIG. 4 is the rear view of the illumination device 2. As shown in FIG. 4, a power supply substrate 8 is arranged on the rear surface of the illumination device 2. The power supply substrate 8 is disposed between the two electrodes 17 at the opposite ends (see FIG. 3) in the plan view of the chassis 4, and the power supply substrate 8 occupies only a small area in the chassis 4. The power supply substrate 8 is connected to the chassis 4 and to the discharge tubes 20 through the relay connectors 14, and serves as an inverter circuit to supply power to the discharge tubes 20. The power supply substrate 8 is affixed to the chassis 4 by a conductive fixture (not shown in the figure) such that the ground potential of the chassis 4 and the ground potential of the power supply substrate 8 become equal. The power supply substrate 8 includes a circuit board 6 and two transformers 10a and 10b.

The two transformers 10a and 10b are arranged in parallel with each other along the shorter side direction of the chassis 4, and are disposed on the rear surface of the circuit board 6 so as to be incorporated in the power supply substrate 8. The respective transformers 10a and 10b are electrically connected to the circuit board 6 and the relay connectors 14 (the four electrodes 17 in between in the plan view of the chassis 4 (see FIG. 2)) through circuit wiring lines 32. Specifically, two adjacent electrodes 17 that respectively belong to two adjacent discharge tubes 20 are electrically connected to one transformer 10a (10b), respectively. The two electrodes 17 connected to the transformer 10a are respectively applied with alternating currents P1 and P2 of the same phase. The electrodes 17 connected to the transformer 10b are respectively applied with alternating currents P3 and P4 of the same phase. The alternating currents P1 to P4 applied to the respective discharge tubes 20 are adjusted by the transformers 10a and 10b, respectively.

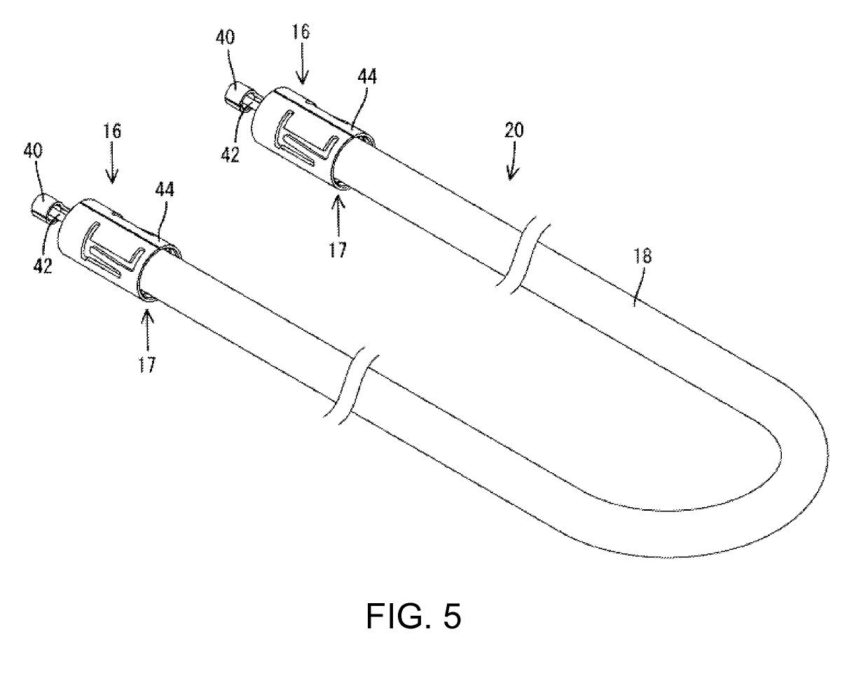

Next, the discharge tubes 20 will be explained. FIG. 5 is a perspective view of one of the discharge tubes 20. As shown in FIG. 5, the discharge tube 20 includes outer leads 42 and the sockets 16. The outer leads 42 are formed so as to protrude from the respective ends of the glass tube 18, and are provided with power from the power supply substrate 8. The sockets 16 are attached to the outer circumferences of the respective ends of the glass tube 18, and each of the sockets 16 includes a main body 44 and a conductive section 40. The main body 44 is electrically connected to the power supply substrate 8. The conductive section 40 is extended from the main body 44, and is electrically connected to the outer lead 42. Here, the discharge tubes 20 are made of cold cathode lamps, and therefore, dimming can be performed with ease as compared with common fluorescent lamps.

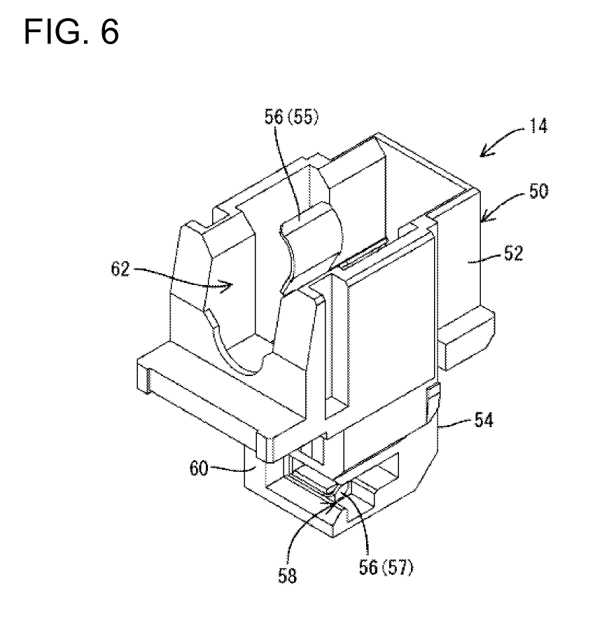

Next, the relay connectors 14 will be explained. FIG. 6 is a perspective view of one of the relay connectors 14. The relay connector 14 is configured so as to be inserted to the attachment hole 4H formed in the chassis 4, and can therefore be affixed to the chassis 4. Specifically, the relay connector 14 includes a holder 50 made of a synthetic resin and a relay terminal 56 made of a metal that is housed in the holder 50. The holder 50 is provided to insulate the relay terminal 56 from the chassis 4, and to attach the relay connector 14 to the chassis 4. The relay terminal 56 is attached to the holder 50 so as to electrically connect the power supply substrate 8 to the discharge tubes 20. The relay terminal 56 includes a discharge tube side connecting portion 55 that is electrically connected to the discharge tubes 20, and a power supply substrate side connecting portion 57 that is electrically connected to the power supply substrate 8. The power supply substrate side connecting portion 57 includes a pair of elastic materials (not shown in the figure) capable of sandwiching the power supply substrate 8 with elasticity.

The holder 50 is constituted of a box-shaped portion (socket housing portion) 52 that has a block shape as a whole and that is to be disposed on the front side (the side on which the discharge tubes 20 are formed) of the chassis 4, and a projected portion (power supply substrate housing portion) 54 that is to be disposed on the rear side (the side on which the power supply substrate 8 is formed) of the chassis 4 and that can be inserted to the attachment holes 4H of the chassis 4. The box-shaped portion 52 has a housing chamber 62 that is open toward two directions so as to house an end of the discharge tube 20. When the socket 16 formed at an end of the discharge tube 20 is housed in the housing chamber 62, and the conductive section 40 of the socket 16 is attached to the discharge tube side connecting portion 55, an electrical connection between the discharge tube 20 and the relay connector 14 is established.

The projected portion 54 has an insertion opening 58 that allows a part of the power supply substrate 8 to be inserted thereto. Also, the projected portion 54 has a holder wall portion 60 that bridges the insertion opening 58. The holder wall portion 60 has a shape that can engage a part of the power supply substrate 8, that is, the holder wall portion 60 can engage a part of the power supply substrate 8, and by this engagement, the power supply substrate 8 and the holder 50 are properly positioned to each other, and are thereby assembled. The manner in which the circuit board 6 is connected to the relay connectors 14 will be described later with reference to other figures.

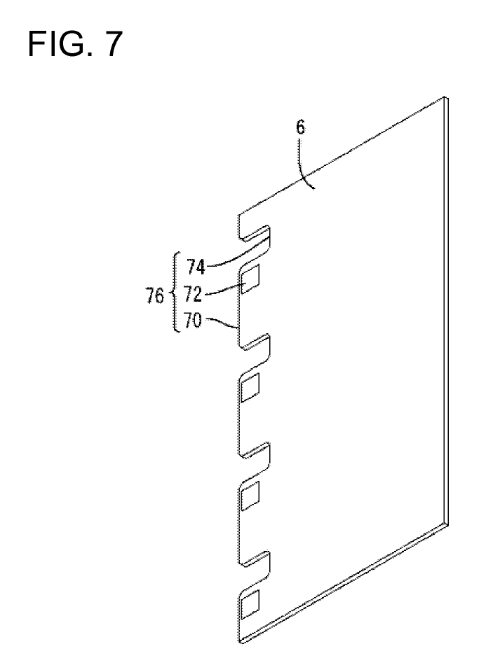

FIG. 7 is a perspective view of the circuit board 6 that constitutes the power supply substrate 8. The circuit board 6 as a whole has a rectangular shape that is vertically long, and is made of paper-based phenolic resin copper clad laminates (referred to as a paper phenol). At an edge of the circuit board 6, engagement portions 76 that engage the relay connectors 14 are formed. Each of the engagement portions 76 has a recess 74, a projection 40, and a conductive portion (terminal portion) 72 for delivering power to the relay connector 14.

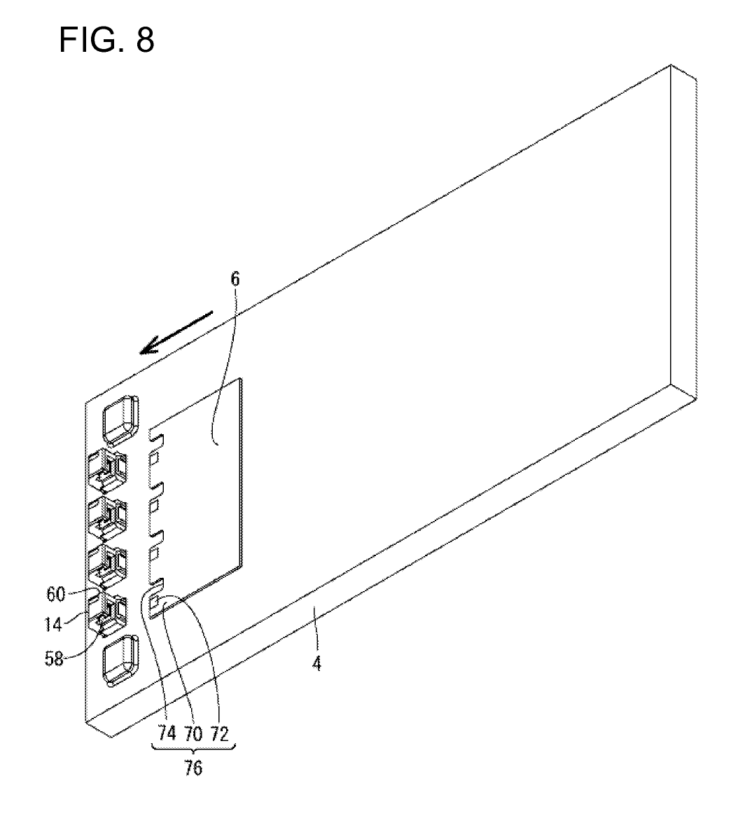

Next, a manner in which this circuit board 6 is assembled to the chassis 4, that is, a manner in which the circuit board 6 is connected to the relay connecters 14, will be described. FIG. 8 is an explanatory view showing the manner in which the circuit board 6 is connected to the relay connecters 14. First, while aligning the circuit board 17 to the relay connectors 14 such that the holder wall portions 60, which are formed in the holders 50 of the relay connectors 14, engage the recesses 74 of the circuit board 6, the projections 70 of the circuit board 6 are inserted to the insertion openings 58, which are formed in the holders 50 of the relay connectors 14. This establishes an engagement between the holder wall portions 24 and the recesses 74. Next, the projections 70 of the engagement portions 76 are inserted further into the insertion openings 58 of the relay connectors 14 (holders 50) so as to be sandwiched by elastic materials formed in the power supply substrate side connecting portions 57 of the relay terminals 56. As a result, an electrical connection between the power supply substrate 8 and the relay connectors 14 is secured.

The television receiver TV of this embodiment has been described in detail. In the illumination device 2 of the television receiver TV according to this embodiment, the two electrodes 17 at the opposite ends are not connected to the transformers 10a or 10b, and respective two electrodes 17 are connected to one transformer 10a (10b). In the plan view of the chassis 4, the two transformers 10a and 10b are arranged in parallel with each other, and each of the transformers 10a and 10b is electrically connected to two adjacent electrodes 17 that respectively belong to two adjacent discharge tubes 20. Further, in the discharge tube 20 disposed in between, the two electrodes 17 at the respective ends are connected to the transformers 10a and 10b, respectively, and the center portion is virtually grounded. Therefore, even when three discharge tubes 20 are arranged in the chassis, the number of the transformers 10a and 10b connected to the electrodes 17 can be reduced below the number of the discharge tubes 20. This makes it possible to reduce the manufacturing cost of the transformers 10a and 10b.

In the above-mentioned embodiment, three discharge tubes 20 are arranged in parallel with each other in the chassis 4. Therefore, three discharge tubes 20 are housed efficiently in the chassis 4.

In the above-mentioned embodiment, the respective electrodes 17 connected to the same transformer 10a (10b) are applied with the alternating currents P1 and P2 of the same phase or P3 and P4 of the same phase. This improves the reliability of the illumination device 2 such as a breakdown voltage.

Further, in the above-mentioned embodiment, the illumination device 2 is provided with the power supply substrate 8, and in the plan view of the chassis 4, the electrodes 17 in between are electrically connected to the power supply substrate 8, and the power supply substrate 8 is arranged between the two electrodes 17 at the opposite ends. Therefore, by disposing the power supply substrate 8 near the four electrodes 17 in between, the size of the power supply substrate 8 can be made smaller.

In the above-mentioned embodiment, the transformers 10a and 10b are incorporated in the power supply substrate 8. This allows the transformers 10a and 10b to be manufactured in the same step as that of the power supply substrate 8, and the manufacturing process of the illumination device 2 can therefore be simplified.

In the above-mentioned embodiment, the ground potential of the chassis 4 and the ground potential of the power supply substrate 8 are held at the same potential by a conductive fixture. This can achieve the stable potential between the chassis 4 and the power supply substrate 8, and the discharge tubes 20 can therefore be turned on with ease.

Also, in the above-mentioned embodiment, the sockets 16 constituting the electrodes 17 are housed in the socket housing chambers 62, which electrically connects the discharge tubes 20 to the power supply substrate 8 through the relay connectors 14. This makes it possible to directly and easily connect the discharge tubes 20 to the power supply substrate 8 without using lead wires.

In the above-mentioned embodiment, the engagement portions 76 that engage the insertion openings 58 are formed at an edge of the power supply substrate 8, and each of the engagement portions 76 includes a recess 74 that sandwiches the insertion opening 58. Therefore, it is possible to achieve a card edge-type connection between the relay connectors 14 and the power supply substrate 8, and the two members can be connected to each other with ease.

Further, in the above-mentioned embodiment, each of the relay connectors 14 includes the insulating holder 50 and the relay terminal 56 attached to the holder 50. This makes it possible to prevent a current flowing through the relay connectors 14 from leaking from the relay terminal 56 into the chassis 4, while securing conduction between the power supply substrate 8 and the discharge tubes 20.

In the above-mentioned embodiment, the ground terminals 30 are attached to the chassis 4. Therefore, the discharge tubes 20 and the chassis 4 can be directly connected without using lead wires, and the electrodes 17 of the discharge tubes 20 that are not connected to the power supply substrate 8 can be held at the ground potential.

Also, in the above-mentioned embodiment, in the plan view of the chassis 4, all of the electrodes 17 formed at the respective ends of the discharge tubes 20 are aligned on the straight line L1 that is parallel with the shorter side direction of the chassis 4. Therefore, three discharge tubes 20 are housed efficiently in the chassis 4.

### Embodiment 2

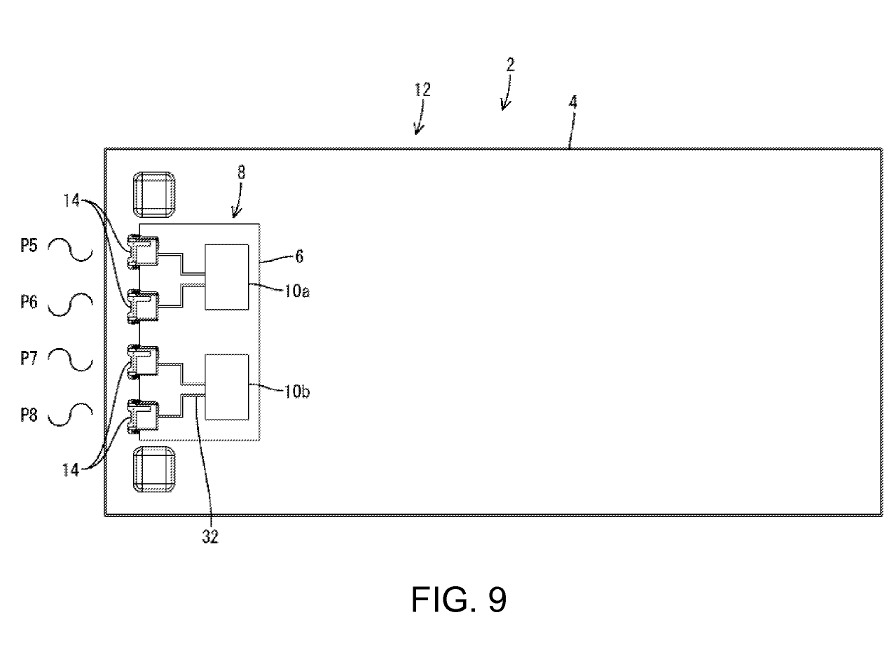

FIG. 9 is a rear view of an illumination device 2 according to Embodiment 2. Embodiment 2 differs from Embodiment 1 in the phases of alternating voltages applied to the four electrodes 17 in between in the plan view of the chassis 4. Other configurations are the same as those of Embodiment 1 above, and therefore, the same reference characters are given to the same components, and descriptions of their configurations, functions, and effects are omitted.

In Embodiment 2, alternating currents P5 and P6 having opposite phases from each other are respectively applied to the two electrodes 17 connected to the transformer 10a. Alternating currents P7 and P8 having opposite phases from each other are respectively applied to two electrodes 17 connected to the transformer 10b. Therefore, the electromagnetic noise generated in the display panel 22 is balanced out, which suppresses the effect of the electromagnetic noise.

### Embodiment 3

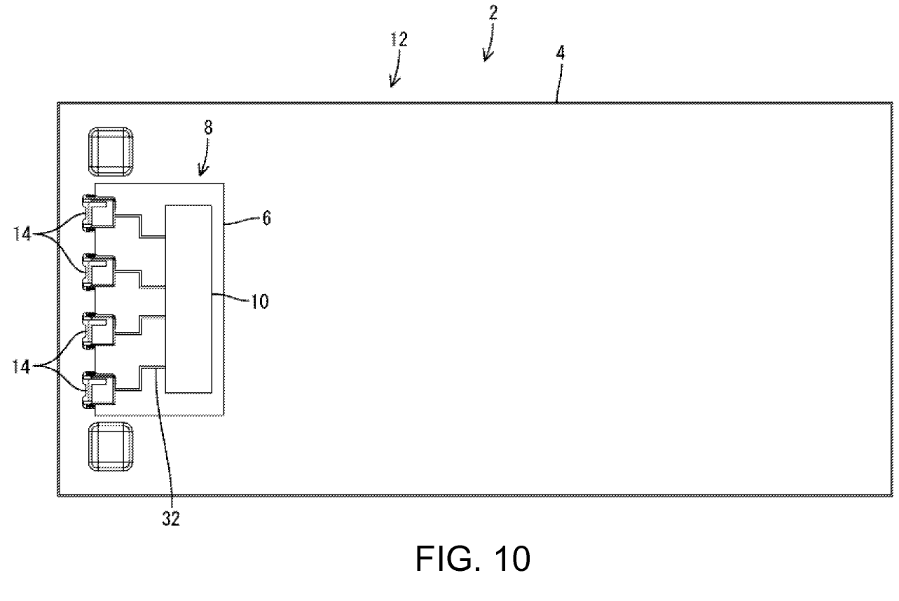

FIG. 10 is a rear view of an illumination device 2 according to Embodiment 3. Embodiment 3 differs from Embodiment 1 in the number of the transformers 10 disposed on the rear surface of the circuit board 6 in the plan view of the chassis 4. Other configurations are the same as those of Embodiment 1 above, and therefore, the same reference characters are given to the same components, and descriptions of their configurations, functions, and effects are omitted.

In Embodiment 3, in the plan view of the chassis 4, all of the electrodes (four electrodes) 17 in between are electrically connected to one transformer 10. Even in such a configuration, a voltage inside of the discharge tubes 20 can be adjusted by the transformer 10. Also, because this configuration requires only one transformer 10, the manufacturing cost of the transformer 10 can be reduced.

### Embodiment 4

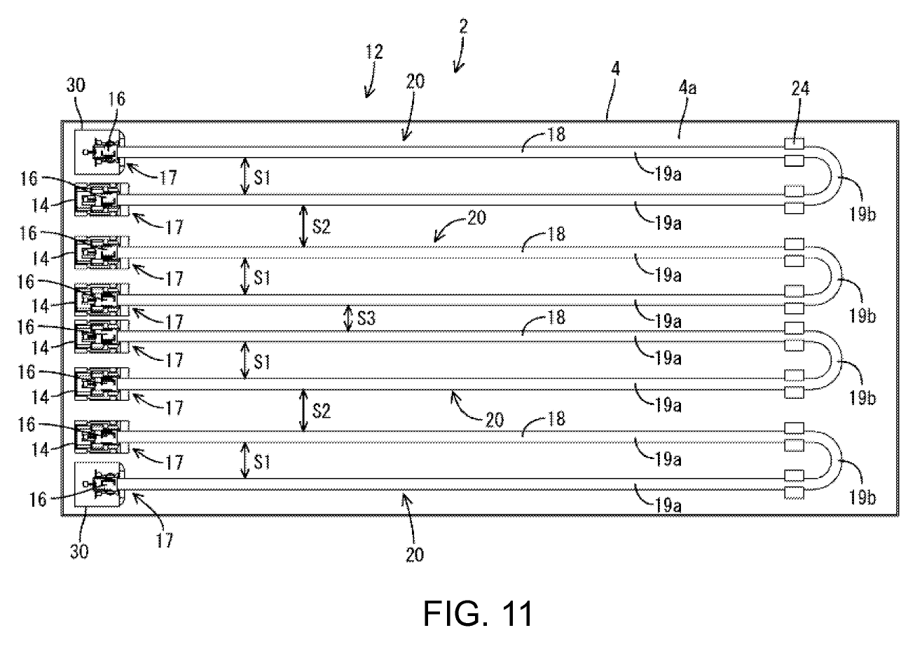

FIG. 11 is a front view of an illumination device 2 according to Embodiment 4. Embodiment 4 differs from Embodiment 1 in the number of discharge tubes 20 arranged in the chassis 4, and in the distance between the respective straight sections 19a of adjacent discharge tubes 20. Other configurations are the same as those of Embodiment 1 above, and therefore, the same reference characters are given to the same components, and descriptions of their configurations, functions, and effects are omitted.

In Embodiment 4, four discharge tubes 20 are arranged in parallel with each other in the chassis 4. In the plan view of the chassis 4, the four discharge tubes 20 are arranged in parallel with each other such that the electrodes 17 are aligned in one direction. Even in this case, the number of transformers connected to the electrodes 17 can be reduced below the number of discharge tubes 20, and therefore, the manufacturing cost of the transformers can be reduced.

Moreover, in Embodiment 4, in the plan view of the chassis 4, the four discharge tubes 20 are respectively arranged such that the distances between straight sections 19a of respective adjacent discharge tubes 20 become larger as the discharge tubes 20 are located further away from the center. Specifically, the discharge tubes 20 are respectively arranged such that a distance S2 between the straight section 19a of each of the discharge tubes 20 disposed at the ends and the straight section 19a of each of the discharge tubes 20 in between becomes larger than a distance S3 between the respective straight sections 19a of the two discharge tubes 20 in between. Distances S1 between the straight sections in the respective discharge tubes 20 are set to be equal to each other. According to the configuration of Embodiment 4, the brightness of the center portion of the chassis 4 can be increased as compared with a configuration in which the same number of the discharge tubes 20 is arranged in the chassis 4 at equal distances. This allows for a reduction in the power consumption of the illumination device 2.

### Embodiment 5

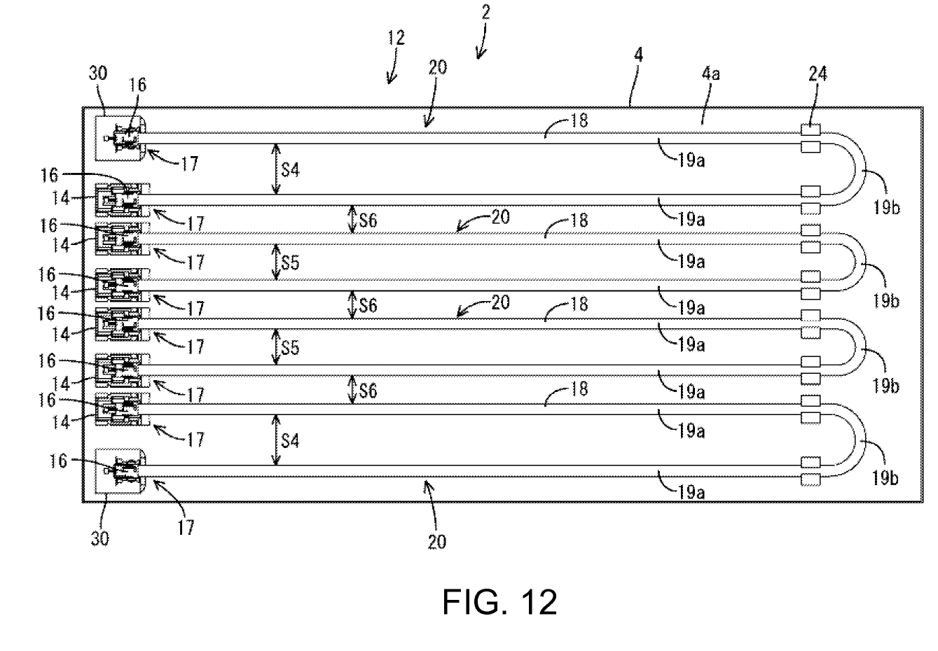

FIG. 12 is a front view of an illumination device 2 according to Embodiment 5. Embodiment 5 differs from Embodiment 1 in that a distance between the straight sections 19a of a single discharge tube varies among the discharge tubes 20. Other configurations are the same as those of Embodiment 1 above, and therefore, the same reference characters are given to the same components, and descriptions of their configurations, functions, and effects are omitted.

In Embodiment 5, four discharge tubes 20 are arranged in parallel with each other in the chassis 4. A distance between the straight sections 19a of a single discharge tube varies among the four discharge tubes 20 in the plan view of the chassis 4, and the distance becomes larger as the discharge tubes 20 is located further away from the center. Specifically, the discharge tubes 20 are respectively configured such that a distance S4 between the straight sections 19a of each of the two discharge tubes 20 disposed at the ends becomes larger than a distance S5 between the straight sections 19a of each of the two discharge tubes 20 in between. In the respective discharge tubes 20, distances S6 between straight sections 19a of adjacent discharge tubes 20 are equal to each other. According to the configuration of Embodiment 5, the brightness of the center portion of the chassis 4 can be increased as compared with a configuration in which the same number of the discharge tubes 20 that respectively have the same distance between the straight sections 19a is disposed in the chassis 4. This allows for a reduction in the power consumption of the illumination device 2.

### Embodiment 6

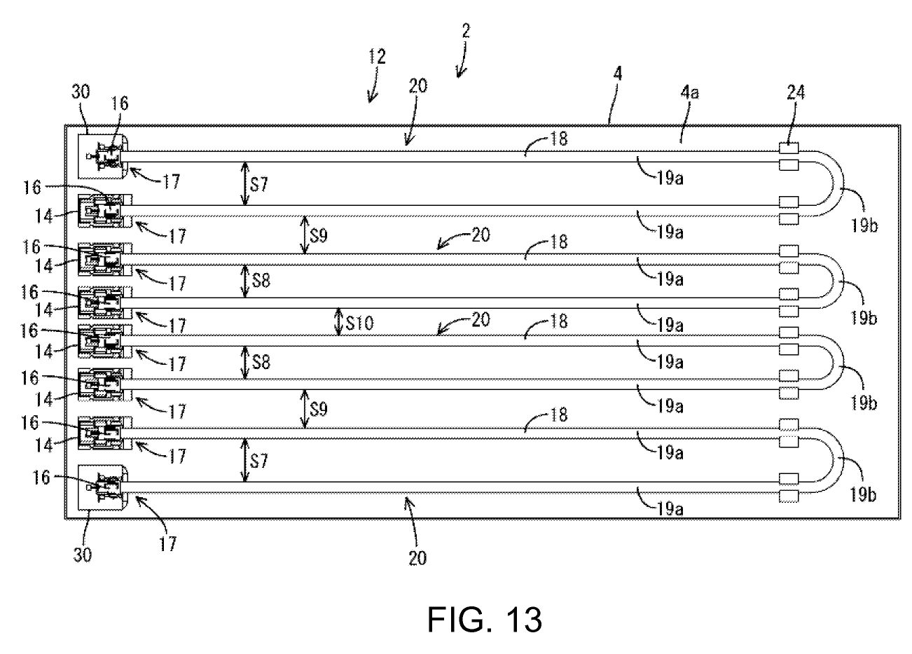

FIG. 13 is a front view of an illumination device 2 according to Embodiment 6. Embodiment 6 differs from Embodiment 1 in the number of discharge tubes 20 arranged in the chassis 4 and the distances between the straight sections 19a of respective adjacent discharge tubes 20. Other configurations are the same as those of Embodiment 1 above, and therefore, the same reference characters are given to the same components, and descriptions of their configurations, functions, and effects are omitted.

In the illumination device 2 of Embodiment 6, four discharge tubes 20 are arranged in parallel with each other in the chassis 4. In the plan view of the chassis 4, among the respective four discharge tubes 20, the discharge tubes 20 located further away from the center have a larger distance between the straight sections 19a of respective adjacent discharge tubes 20 and a larger distance between the straight sections 19a of each discharge tube 20. Specifically, the discharge tubes 20 are respectively arranged such that a distance S9 between the straight section 19a of each of the discharge tubes 20 disposed at the ends and the straight section 19a of each of the discharge tubes 20 in between becomes larger than the distance S10 between the straight sections 19a of the two adjacent discharge tubes 20 in between. Further, the respective discharge tubes 20 are configured such that a distance S7 between the straight sections 19a of each of the two discharge tubes 20 disposed at the ends becomes larger than a distance S8 between the straight sections 19a of each of the two discharge tubes 20 in between. According to the configuration of Embodiment 6, the brightness of the center portion of the chassis 4 can be increased as compared with a configuration in which the same number of discharge tubes 20 is arranged at equal distances in the chassis 4 or a configuration in which the same number of discharge tubes 20 that respectively have the same distance between the straight sections 19a of each discharge tube are arranged in the chassis 4. This allows for a reduction in the power consumption of the illumination device 2.

### Embodiment 7

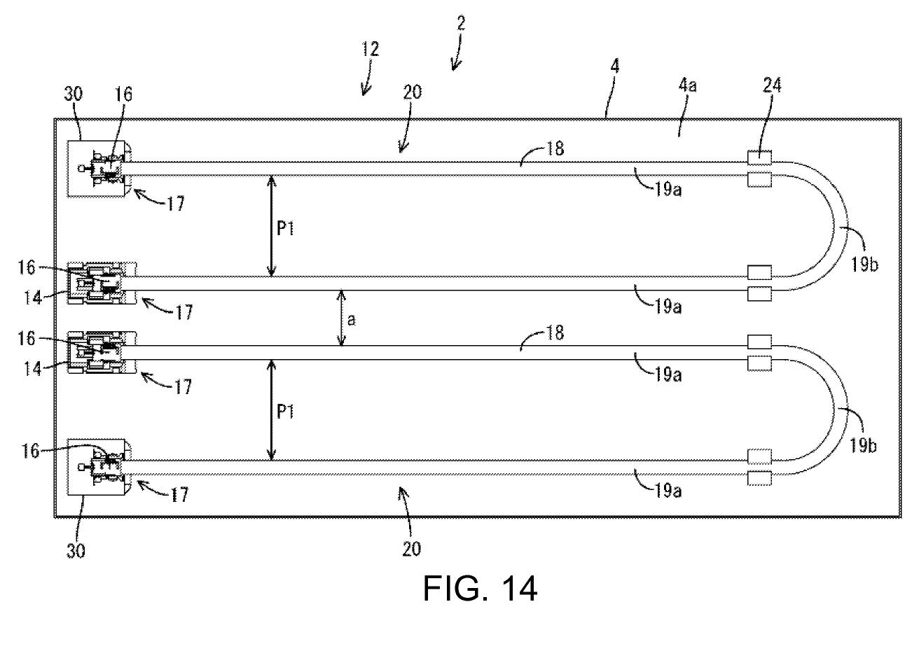

FIG. 14 is a front view of an illumination device 2 according to Embodiment 7. Embodiment 7 differs from Embodiment 1 in the number of discharge tubes 20 arranged in the chassis 4 and the distance between the straight sections 19a of adjacent discharge tubes 20. Other configurations are the same as those of Embodiment 1 above, and therefore, the same reference characters are given to the same components, and descriptions of their configurations, functions, and effects are omitted.

In the illumination device 2 of Embodiment 7, two discharge tubes 20 are arranged in parallel with each other in the chassis 4. In the respective discharge tubes 20, a relation represented by “P1>a” is satisfied, where P1 is a distance between the straight sections 19a of each discharge tube 20, and “a” is a distance between the straight sections 19a that face each other between the adjacent discharge tubes 20. According to the configuration of Embodiment 7, because two discharge tubes 20 are arranged in the chassis 4 so as to satisfy the above-mentioned relation, the brightness of the center portion of the chassis 4 can be increased. This allows for a reduction in the power consumption of the illumination device 2.

### Embodiment 8

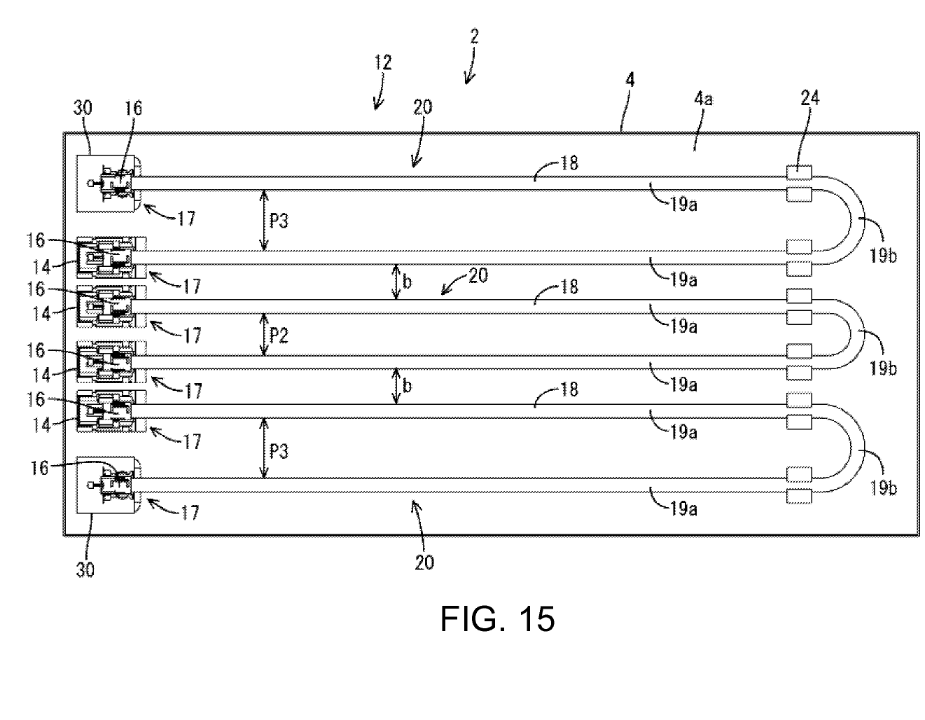

FIG. 15 is a front view of an illumination device 2 according to Embodiment 8. Embodiment 8 differs from Embodiment 1 in the number of discharge tubes 20 arranged in the chassis 4 and the distance between straight sections 19a of adjacent discharge tubes 20. Other configurations are the same as those of Embodiment 1 above, and therefore, the same reference characters are given to the same components, and descriptions of their configurations, function, and effects are omitted.

In the illumination device 2 of Embodiment 8, three discharge tubes 20 are arranged in the chassis 4. In the discharge tubes 20 disposed at the ends, the distances between straight sections 19a in the respective discharge tubes 20 are set to be the same. Further, a relation represented by P3>P2 and P2<⅓× (2×b+P3) is satisfied, where P2 is a distance between straight sections 19a that face each other in the one discharge tube 20 in between; P3 is a distance between straight sections 19a that face each other in each of the discharge tubes 20 disposed at the ends; and “b” is a distance between straight sections 19a of respective two adjacent discharge tubes 20. According to the configuration of Embodiment 8, because the three discharge tubes 20 are arranged in the chassis 4 so as to satisfy the above-mentioned relation, the brightness of the center portion of the chassis 4 can be increased. This allows for a reduction in the power consumption of the illumination device 2.

The correspondence relation between the configuration of the embodiments and the configuration of the present invention is described as follows: the glass tube 18 is one example of the “tubular body;” the transformers 10a, 10b, and 10 are examples of the “adjustment circuits;” the ground terminal 30 is one example of the “ground connector;” and the housing chamber 62 is one example of the “socket housing chamber”.

Modification examples of the respective embodiments above are as follows.

(1) The display panel of the display device device is not limited to a display panel having TFTs as switching elements, and a display panel having other switching elements than TFTs such as MIM (Metal Insulator Metal) may also be used.

(2) In the respective embodiments above, the cold cathode lamps were described as an example of the discharge tubes, but alternatively, hot cathode lamps can be used, for example. Further, as other types of discharge tubes, sodium lamps, mercury lamps, metal halide lamps, and xenon lamps may also be used.

(3) In the respective embodiments above, the U-shaped discharge tube was described as an example, but the shape of the discharge tube is not limited to such. As long as the discharge tube is curved such that the electrodes are aligned in one direction, a pseudo U-shape, an angular U-shape, and the like may be employed.

(4) The electrodes do not necessarily have to be aligned on a straight line that is parallel with the shorter side direction of the chassis as long as they are aligned in one direction.

(5) In the respective embodiments above, examples of using two or one transformers were described, but as long as the number of transformers is below the number of electrodes, there is no special limitation on the number of the transformers.

(6) In the respective embodiments above, examples of incorporating the transformers into the power supply substrate were described, but the transformers and the power supply substrate may be separately arranged on the rear surface of the chassis.

(7) In the respective embodiments above, the cold cathode tube having sockets was described as an example, but a cold cathode tube that does not include sockets and that has the lead terminals exposed at the ends of the glass tube may also be used. In this case, the connection terminals may not be provided in the cold cathode tube holder, and wiring lines may be directly connected to the lead terminals of the cold cathode tube by soldering or the like.

(8) In addition to the respective embodiments above, the cold cathode lamps can be appropriately modified in terms of the number, the length, the size, the arrangement pattern in the chassis, and the like.

(9) The display device is not limited to a liquid crystal display device, and includes various other display devices that require an illumination device disposed on the rear surface of the display panel thereof.

(10) In the respective embodiments above, the liquid crystal display device in which the liquid crystal panel is used as the display panel was described as an example, but the present invention can be applied to a display device using other kinds of display panels.

(11) In the respective embodiments above, a television receiver provided with a tuner was described as an example, but the present invention can be applied to a display device that is not provided with a tuner.

Embodiments of the present invention described above in detail are merely examples, and do not limit the scope of the claims. The techniques described in the scope of the claims include various modifications and changes of the specific examples shown above.

The technical elements described in the present specification or drawings demonstrate the technical utility either singly or in various combinations, and are not limited to the combinations described in the claims at the time of the filing of the present application. Further, the techniques described as examples in the present specification or drawings can simultaneously achieve a plurality of objects, and have technical utility by virtue of the achievement itself of a single object among these objects.

### Description of Reference Characters

TV: television receiver
D: display device
2: illumination device
4: chassis
4H: attachment hole
6: circuit board
8: power supply substrate
10, 10a, 10b: transformers
12: lamp unit
14: relay connector
16: socket
17: electrode
18: glass tube
19a: straight section
19b: curved section
20: discharge tube
22: display panel
24: lamp clip
30: ground terminal
32: circuit wiring line
34: projection
36: conductive portion (terminal portion)
38: recess
39: engagement portion
40: conductive section
42: outer lead
44: main body
50: holder
52: box-shaped portion
54: projection
55: discharge tube side connecting portion
56: relay terminal
57: power supply substrate side connecting portion
58: insertion opening
60: holder wall portion
62: housing chamber
70: projection
72: conductive portion
74: recess
76: engagement portion

1. An illumination device, comprising:
a plurality of discharge tubes, each of which has electrodes at respective ends of a tubular body, the tubular body being bent such that the electrodes are aligned in one direction;
a chassis that houses said plurality of discharge tubes; and
an adjustment circuit that adjusts driving power supplied to said discharge tubes,
wherein, in a plan view of said chassis, said discharge tubes are arranged in parallel in said chassis such that said electrodes of the plurality of discharge tubes are aligned in one direction,
wherein, among said electrodes aligned in one direction, said electrodes in between are electrically connected to said adjustment circuit, and two of said electrodes at opposite ends are electrically connected to said chassis, and
wherein two or more of said in-between electrodes are electrically connected to the same adjustment circuit.

2. The illumination device according to claim 1, wherein three or more of said discharge tubes are arranged in said chassis, and
wherein, in a plan view of said chassis, among three or more of said discharge tubes arranged in parallel with each other in said chassis, said discharge tube in between has two said electrodes at respective ends thereof connected to said adjustment circuit and a center portion thereof virtually grounded.

3. The illumination device according to claim 1,
wherein, in a plan view of said chassis, all of said in-between electrodes are electrically connected to the same adjustment circuit.

4. The illumination device according to claim 1,
wherein, in a plan view of said chassis, a plurality of said adjustment circuits are arranged in parallel with each other, and each of said adjustment circuits is electrically connected to two adjacent said electrodes that respectively belong to two adjacent said discharge tubes.

5. The illumination device according to claim 1, wherein said tubular body includes two straight sections parallel with each other and one curved section formed between two said straight sections,
wherein each of two said straight sections has said electrode at one end, and the other end thereof is continued to said curved section, and
wherein, in a plan view of said chassis, a plurality of said discharge tubes are arranged such that respective said straight sections constituting the plurality of discharge tubes become parallel with each other.

6. The illumination device according to claim 5, wherein four or more of said discharge tubes are arranged in said chassis, and
wherein, in a plan view of said chassis, the respective plurality of discharge tubes are arranged such that a distance between said straight sections of the adjacent discharge tubes becomes larger as said discharge tube is located further away from a center.

7. The illumination device according to claim 5, wherein three or more of said discharge tubes are arranged in said chassis, and
wherein, in a plan view of said chassis, the plurality of discharge tubes are configured such that a distance between said straight sections of the same discharge tube varies among the plurality of discharge tubes and such that said distance becomes larger as said discharge tube is located further away from a center.

8. The illumination device according to claim 5, wherein three of said discharge tubes are arranged in said chassis,
wherein, in a plan view of said chassis, distances between said straight sections of the respective discharge tubes are set to be equal in two discharge tubes located at the ends among said discharge tubes,
wherein a relation represented by P3>P2 and P2<⅓× (2×b+P3) is satisfied, where:
P2 is a distance between said straight sections that face each other in one discharge tube in between among said discharge tubes;
P3 is a distance between said straight sections that face each other in each of the two discharge tubes located outside among said discharge tubes; and
“b” is a distance between said straight sections of respective two adjacent discharge tubes among said discharge tubes.

9. The illumination device according to claim 1, wherein two said discharge tubes are arranged in said chassis,
wherein said tubular body includes two straight sections that are parallel with each other and one curved section formed between the two straight sections,
wherein each of the two straight sections has said electrode at one end, and the other end thereof is continued to said curved section,
wherein, in a plan view of said chassis, the plurality of discharge tubes are arranged such that said straight sections in the plurality of discharge tubes become parallel with each other, and
wherein said two discharge tubes satisfy a relation represented by P1>a, where P1 is a distance between said straight sections in each of said discharge tubes, and “a” is a distance between said straight sections that face each other between the adjacent discharge tubes.

10. The illumination device according to claim 1, wherein an alternating current of a same phase is applied to respective electrodes connected to the same adjustment circuit.

11. The illumination device according to claim 1, wherein a half of electrodes connected to the same adjustment circuit is applied with an alternating current of a same phase, and a remaining half is applied with an alternating current of a phase that is opposite to said alternating current of said phase.

12. The illumination device according to claim 1, further comprising a power supply substrate,
wherein, in a plan view of said chassis, said electrodes in between are electrically connected to said power supply substrate.

13. The illumination device according to claim 12, wherein, in a plan view of said chassis, said power supply substrate is arranged between two of said electrodes at opposite ends.

14. The illumination device according to claim 12, wherein said adjustment circuit is incorporated in said power supply substrate.

15. The illumination device according to claim 12, wherein a ground potential of said chassis and a ground potential of said power supply substrate are equal.

16. The illumination device according to claim 12, further comprising a relay connector attached to said chassis,
wherein said electrode is electrically connected to said power supply substrate through said relay connector.

17. The illumination device according to claim 16,
wherein said discharge tube comprises:
an outer lead that is formed so as to protrude from an end of said tubular body and that is supplied with power from said power supply substrate; and
a socket including a main body that is attached to an outer circumference of said tubular body and that is provided with a connecting portion electrically connected to said power supply substrate, the socket also including a conductive section that extends from said main body and that is connected to said outer lead,
wherein said socket constitutes said electrode, and
wherein said relay connector has a socket housing chamber that houses said socket.

18. The illumination device according to claim 16,
wherein said relay connector has an insertion opening that allows said power supply substrate to be inserted thereto,
wherein said power supply substrate has, at an edge thereof, an engagement portion that engages said insertion opening, and
wherein said relay connector and said power supply substrate are electrically connected.

19. The illumination device according to claim 18, wherein said engagement portion has a recess that sandwiches a wall portion that is formed so as to bridge said insertion opening.

20. The illumination device according to claim 16,
wherein said relay connector includes an insulating holder attached to said chassis and a relay terminal that is attached to the said holder and that can be electrically connected to said power supply substrate and said discharge tube.

21. The illumination device according to claim 1, further comprising a ground connector attached to said chassis,
wherein said electrode is electrically connected to said chassis through said ground connector.

22. The illumination device according to claim 1, wherein, in a plan view of said chassis, said electrodes are aligned on a straight line that is parallel with a shorter side direction of said chassis.

23. A display device comprising a display panel that performs a display using light from the illumination device according to claim 1.

24. The display device according to claim 23, wherein said display panel is a liquid crystal panel that uses liquid crystals.

25. A television receiver comprising the display device according to claim 23.
